(19) United States
(12) Patent Application Publication
(10) Pub. No.: US 2025/0355394 A1
(43) Pub. Date: Nov. 20, 2025

(54) SHEET FEEDING APPARATUS AND IMAGE FORMING APPARATUS

(71) Applicant: CANON KABUSHIKI KAISHA, Tokyo (JP)

(72) Inventors: SEIYA FUJIYAMA, Chiba (JP); SHO OTA, Chiba (JP)

(21) Appl. No.: 19/175,365

(22) Filed: Apr. 10, 2025

(30) Foreign Application Priority Data
May 15, 2024 (JP) 2024-079285

(51) Int. Cl. G03G 15/00

(52) U.S. Cl. CPC G03G 15/6511; G03G 15/6514

(57) ABSTRACT

Disclosed is a sheet feeding apparatus including a first sheet stacking portion on which a sheet is stacked; a sheet side end restricting portion that restricts a side end of the sheet stacked on the first sheet stacking portion; and a second sheet stacking portion on which the sheet is stacked. The sheet feeding apparatus further comprises an indication portion provided on the second stacking portion, the indication portion indicating positions of both side ends of the sheet in the state where the side end of the sheet is restricted by the sheet side end restricting portion. The second sheet stacking portion is provided in a detachably attachable manner upstream of the first sheet stacking portion in a feeding direction of the sheet.

### BACKGROUND OF THE INVENTION

### Field of the Invention

This invention relates to a sheet feeding apparatus for feeding a sheet and an image forming apparatus such as a copying machine, a printer and a facsimile provided with the sheet feeding apparatus.

### Description of the Related Art

A conventional configuration is known in which an extended sheet tray is attached to a manual sheet feeding apparatus provided on a side wall of the apparatus main body of an image forming apparatus when a long sheet with the length of about 1000 mm to be used as a point-of-purchase display in a store should be printed (for example, Japanese Patent No. 6187440). Such an extended sheet tray is provided with an attaching portion for being attached to the manual sheet feeding apparatus, and a sheet stacking portion for supporting an upstream side of a long sheet in the sheet conveying direction. Further, the sheet stacking portion is generally configured by a wire to reduce weight of the the extended sheet tray.

When a long sheet with a large size in the sheet feeding direction should be set on the sheet feeding apparatus with the extended sheet tray, it is necessary to adjust the position of the sheet in the width direction perpendicular to the sheet feeding direction so as not for the sheet to be set inclinedly with respect to the sheet feeding direction. In this case, it is also necessary to adjust the position of the sheet in the width direction not only in the manual feeding apparatus, but also in the extended sheet tray.

In view of this situation, Japanese Patent Application Laid-open No. 2002-362787 discloses a mechanism for adjusting the position of a long sheet in the width direction by extending a restricting member of the main tray in the width direction as needed. Further, Japanese Utility Model Publication No. H07-18664 discloses the configuration in which a restricting member for restricting a long sheet in the width direction for the extending tray as well as for the main tray.

However, the apparatuses in Japanese Patent Application Laid-open No. 2002-362787 and Japanese Utility Model Publication No. H07-18664 have a problem that the weight and the size of the sheet feeding apparatus becomes large because of the provision of a restricting member that restricts both ends of a long sheet in the width direction.

### SUMMARY OF THE INVENTION

An object of the invention is to provide a sheet feeding apparatus and an image forming apparatus that can be made lightweight and compact besides the position of a sheet in the direction perpendicular to the sheet feeding direction can be adjusted.

A sheet feeding apparatus according to the present invention, comprising:
a first sheet stacking portion on which a sheet is stacked;
a sheet side end restricting portion that restricts a side end of the sheet stacked on the first sheet stacking portion; and
a second sheet stacking portion on which the sheet is stacked,
wherein the sheet feeding apparatus further comprises an indication portion provided on the second sheet stacking portion, the indication portion indicating positions of both side ends of the sheet in the state where the side end of the sheet is restricted by the sheet side end restricting portion, and
wherein the second sheet stacking portion is provided in a detachably attachable manner upstream of the first sheet stacking portion in a feeding direction of the sheet.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to the first embodiment of the present invention.

FIG. 2 is a diagram showing a front view of a sheet conveying apparatus according to the first embodiment of the present invention.

FIG. 3 is a schematic diagram showing a plan view of a sheet feeding apparatus according to the first embodiment of the present invention.

FIG. 4 is a schematic diagram showing a plan view of the sheet feeding apparatus according to the first embodiment of the present invention in the state where a sheet is placed normally.

FIG. 5 is a schematic diagram showing a plan view of the sheet feeding apparatus according to the first embodiment of the present invention in the state where a sheet is placed inclinedly with respect to the sheet feeding direction.

FIG. 6 is a diagram showing an operation of the sheet feeding apparatus according to the first embodiment of the present invention.

FIGS. 7A, 7B and 7C are diagrams respectively showing a plan view of a second indication portion of the sheet feeding apparatus according to the first embodiment of the present invention.

FIG. 8 is a schematic diagram showing a plan view of the sheet feeding apparatus according to the second embodiment of the present invention.

### DESCRIPTION OF THE EMBODIMENTS

In the following, embodiments of the present invention will be described with reference to the figures.

### First Embodiment

### <Configuration of Image Forming Apparatus >

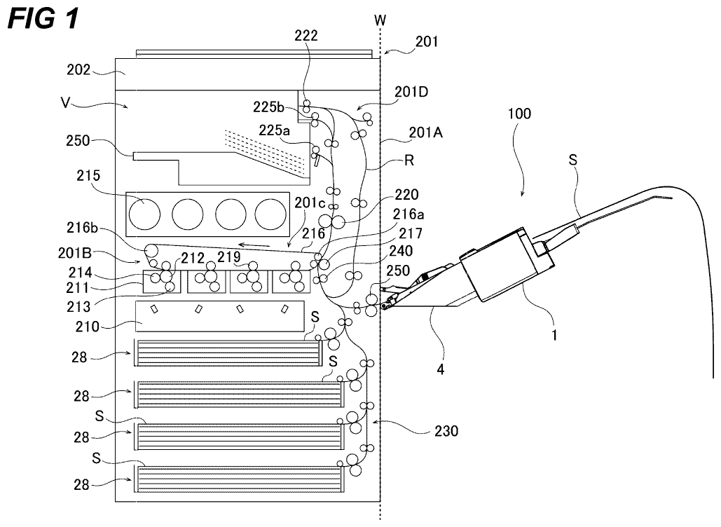

The configuration of the image forming apparatus 201 according to the first embodiment of the present invention will be described in detail with reference to FIG. 1.

The image forming apparatus 201 has the sheet feeding apparatus 100, the apparatus main body 201A, the image forming portion 201B, the double-sided document reversing portion 201D, the image reading portion 202, the first discharge roller pair 225a, the second discharge roller pair 225b, the stacking portion 223, the feeding portion 230, the registration roller 240, and the conveying roller 250. In the image forming apparatus 201, the discharge space V for discharging the sheet S is formed between the image reading apparatus 202 and the apparatus main body 201A in the image forming apparatus 201.

The sheet feeding apparatus 100 is provided on the side wall portion of the apparatus main body 201A and feeds the sheet S toward the registration roller 240. The details of the sheet feeding apparatus 100 will be described later.

The apparatus main body 201A is provided under the image reading apparatus 202 and accommodates the image forming portion 201B and so on.

The image forming portion 201B forms an image of four colors of yellow (Y), magenta (M), cyan (C) and black (K) on the sheet S fed by the feeding portion 230. Specifically, the image forming portion 201B is provided with the intermediate transfer unit 201C, the laser scanner 210, the process cartridge 211, the photosensitive drum 212, the charging device 213, the developing device 214, the toner cartridge 215, the secondary transfer roller 217, the primary transfer roller 219, and the fixing portion 220.

The intermediate transfer unit 201C is provided above the process cartridges 211. Specifically, the intermediate transfer unit 201C is provided with the intermediate transfer belt 216, the driving roller 216a, and the tension roller 216b.

The intermediate transfer belt 216 is wound around the driving roller 216a and the tension roller 216b. The intermediate transfer belt 216 rotates by being driven by the driving roller 216a in the direction of arrow in FIG. 1.

The driving roller 216a stretches the intermediate transfer belt 216 along with the tension roller 216b. The driving roller 216a is driven by a driving portion (not shown).

The tension roller 216b stretches the intermediate transfer belt 216 along with the driving roller 216a.

The surface of the photosensitive drum 212 is uniformly charged at a predetermined polarity and potential by the charging device 213. The laser scanner 210 irradiates the surface of the photosensitive drum 212 with a laser beam based on an electrical signal transmitted from the image reading apparatus 202 to sequentially expose the surface of the photosensitive drum 212. As a result, electrostatic latent images of yellow, magenta, cyan and black are sequentially formed on the photosensitive drum 212.

Four process cartridges 211 are provided corresponding to the four colors of yellow (Y), magenta (M), cyan (C) and black (K). The process cartridges 211 forms toner images of the four colors respectively.

Electrostatic images for yellow, magenta, cyan and black are sequentially formed on the photosensitive drums 212.

The charging device 213 uniformly charges the surface of the photosensitive drum 212 at a predetermined polarity and potential.

The developing device 214 develops an electrostatic latent image for each color formed on each photosensitive drum 212 with toner for each color to visualize the electrostatic latent image.

The toner cartridge 215 supplies the developing device 214 with toner.

The secondary transfer roller 217 is provided at a position opposed to the driving roller 216a. By the second transfer bias being applied to the secondary transfer roller 217, the secondary transfer roller 217 transfers the color toner image that has been transferred onto the intermediate transfer belt 216 onto the sheet S fed by the feeding portion 230 in a batch. The secondary transfer roller 217 conveys to the fixing portion 220 the sheet S on which the color toner image has been transferred.

The primary transfer roller 219 is provided in the position opposed to the photosensitive drum 212 inside the intermediate transfer belt 216. The primary transfer roller 219 is in contact with the intermediate transfer belt 216. By the primary transfer bias being applied to the primary transfer roller 219, the primary transfer roller 219 transfers each toner image with negative polarity on each photosensitive drum 212 onto the intermediate transfer belt 216 in a sequentially superimposing manner.

The fixing portion 220 is provided above the secondary transfer roller 217. The fixing portion 220 applies heat and pressure to the sheet S conveyed by the secondary transfer roller 217 to melt and mix the toner of the toner images for respective colors transferred on the sheet S so that toner images for respective colors are fixed as a color image on the sheet S. The fixing portion 220 conveys the sheet S on which the color image has been fixed to the first discharge roller pair 225a or the second discharge roller pair 225b.

The double-sided document reversing portion 201D is provided above the fixing portion 220. The double-sided document reversing portion 201D is provided with the reverse roller pair 222.

The image reading apparatus 202 reads image information of a document. The image reading apparatus 202 image-processes the read image information, converts the image-processed image information into an electrical signal, and transmits it to the laser scanner 210 of the image forming portion 201B.

The first discharge roller pair 225a is provided above and downstream of the fixing portion 220 in the conveying direction of the sheet S. The first discharge roller pair 225a discharges the sheet S conveyed by the fixing portion 220 to the discharge space V.

The second discharge roller pair 225b is provided above and downstream of the fixing portion 220 in the conveying direction of the sheet S. The second discharge roller pair 225b discharges the sheet S conveyed by the fixing portion 220 to the discharge space V.

The stacking portion 223 is provided protruding into the discharge space V. The sheets S discharged by the first discharge roller pair 225a or the second discharge roller pair 225b are stacked on the stacking portion 223.

The reverse roller pair 222 can rotate normally and reversely and conveys the sheet S which has been conveyed by the fixing portion 220 and on which an image has been formed to the re-conveying path R in order to covey the sheet S to the image forming portion 201B again.

The feeding portion 230 is provided at a lower portion of the apparatus main body 201A. The feeding portion 230 accommodates the sheets S and feeds the accommodated sheets S to the image forming portion 201B.

The registration roller 240 adjusts the skew feeding of the sheet S fed by the feeding portion 230 or the conveying roller 250 and conveys the sheet S whose skew feeding has been adjusted to the secondary transfer roller 217.

The conveying roller 250 conveys the sheet S fed by the sheet feeding apparatus 100 to the registration roller 240.

The sheet feeding apparatus 100 of the image forming apparatus 201 with the above described configuration has a pair of downstream side restricting plates (not shown) that restrict both end portions of the sheet S in the direction perpendicular to the conveying direction of the sheet S. Further, a rack (not shown) is provided on the underside of the pair of downstream side restricting plates. When one of the pair of downstream side restricting plates is moved, the other of the pair of downstream side restricting plates can be moved by a pinion (not shown) meshing with the rack.

The sheets S stacked on the sheet feeding apparatus 100 are fed by a roller (not shown) that is in contact with the upper surface of the sheets S and are separated one by one at the nip formed by the feed roller and the retard roller (not shown) to separately feed each of the sheets S to the conveying roller 250.

### <Configuration of Sheet Feeding Apparatus >

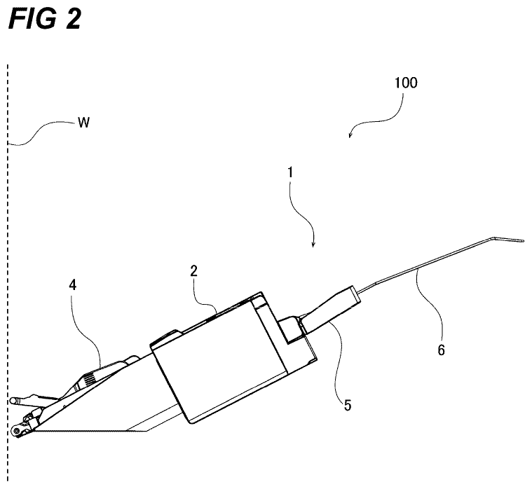

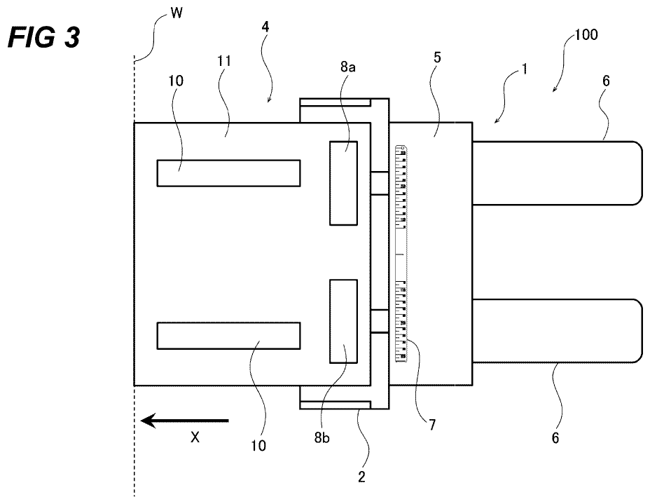

The configuration of the sheet feeding apparatus 100 according to the embodiment of the present invention will be described with reference to FIGS. 2, 3 and 7.

The sheet feeding apparatus 100 has the extended sheet tray 1 and the sheet tray 4.

The extended sheet tray 1 as the second sheet stacking portion is detachably attached to the sheet tray 4 at the upstreaming side of the sheet tray 4 in the feeding direction X of the sheet S. The extended sheet tray 1 is provided with the manual feeding attaching portion 2, the sheet stacking portion 5, the wire portion 6 and the first indication portion 7.

The manual feeding attaching portion 2 is detachably attached to the sheet tray 4.

The sheet stacking portion 5 as the third sheet stacking portion is made from resin. The sheet stacking portion 5 is attached to the manual feeding attaching portion 2 and can stack the sheets S.

The wire portion 6 as the fourth sheet stacking portion is made from metal. The wire portion 6 is attached to the sheet stacking portion 5 at the upstream side of the sheet stacking portion 5 in the feeding direction X and can stack the sheets S.

The first indication portion 7 as the indication portion provided on the second stacking portion is provided along the width direction perpendicular to the feeding direction X on the sheet stacking portion 5. The first indication portion 7 has a single shape. The first indication portion 7 indicates the positions of the sheets S according to their sizes in the width direction perpendicular to the feeding direction X by index markings 16a, 16b and 16c. Specifically, the first indication portion 7 is configured by a label sheet provided with a sticking portion (not shown) to be sticked to the sheet stacking surface of the sheet stacking portion 5.

The index markings 16a, 16b, and 16c respectively indicate the positions of the sheets S according to their regular sizes in the width direction. Specifically, the index markings 16a, 16b, and 16c are displayed on the first indication portion 7 as a label sheet sticked to the sheet stacking surface of the sheet stacking portion 5.

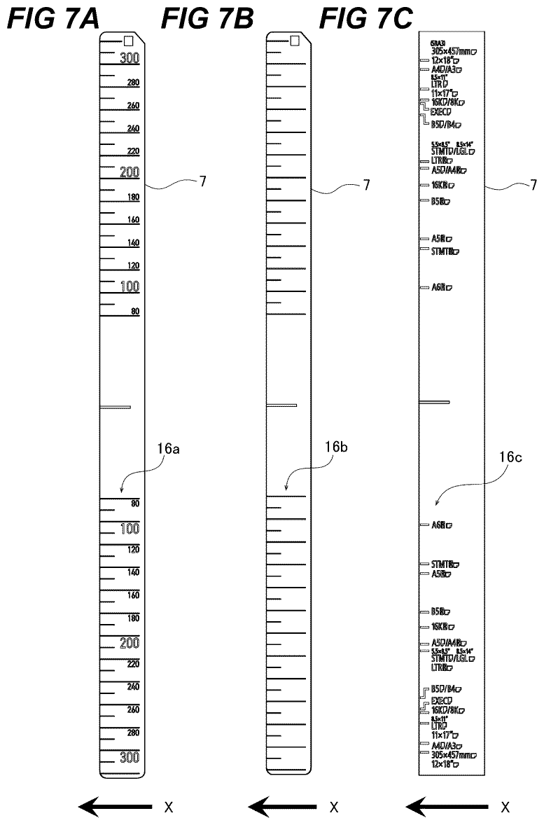

The index markings 16a, 16b, and 16c respectively indicate the distances from the conveying center in the width direction of the first indication portion 7. Specifically, as shown in FIG. 7A, the index marking 16a has the combination of displayed lines with the constant intervals symmetrically with respect to the conveying center in the width direction of the first indication portion 7 and displayed numbers corresponding to the lines. As shown in FIG. 7B, the index marking 16b has only the displayed lines with the constant intervals symmetrically with respect to the conveying center in the width direction of the first indication portion 7. As shown in FIG. 7C, the index marking 16c has the sizes including “B5”, “A4”, “B5R”, “A4R”, “B4”, “A3” and “LTR” and so on displayed symmetrically with respect to the conveying center in the width direction of the first indication portion 7.

The first indication portion 7 can be configured not only by a label sheet but also by engraving the index markings 16a, 16b and 16c on the sheet stacking surface of the sheet stacking portion 5. Further, the first indication portion 7 can be configured by processing the silk print of the index markings 16a, 16b and 16c on the sheet stacking surface of the sheet stacking portion 5.

The sheet tray 4 as the first sheet stacking portion is rotatably provided on the side wall portion of the apparatus main body 201A and can stack the sheets S. The sheets S stacked on the sheet tray 4 are fed to the image forming portion 201B by the conveying roller 250 and the registration roller 240.

The sheet tray 4 is provided with the second indication portion 8, the side restricting members 10 and the main tray 11.

The second indication portion 8a and the second indication portion 8b as an indication portion provided on the first sheet stacking portion is provided between the side restricting members 10 and the first indication portion 7 in the feeding direction X on the main tray 11. The second indication portion 8a and the second indication portion respectively indicate the positions corresponding to the sizes of the sheets S in the width direction. The second indication portion 8a and the second indication portion 8b respectively indicate the positions corresponding to the sizes of the sheets S in the width direction in a similar manner as the index marking 16a, 16b or 16c. Specifically, the second indication portion 8a and the second indication portion 8b are respectively configured by a label sheet with a sticking portion (not shown) to be sticked to the sheet stacking surface of the main tray 11.

The second indication portion 8a and the second indication portion 8b are separated from each other and divided in the width direction. Further, the configuration is not limited to this one in which the second indication portion 8a and the second indication portion 8b are separated from each other and they may have a single configuration that is continuous along the width direction similar to the first indication portion 7.

The second indication portion 8a and the second indication portion 8b can be configured not only by a label sheet but also by engraving the index marking on the sheet stacking surface of the main tray 11. Further, they can be configured by processing the silk print of the index marking on the sheet stacking surface of the main tray 11.

A pair of the side restricting members 10 as a sheet side end restricting portion are provided on the main tray 11 such that the side restricting members 10 are separated from each other in the width direction of the sheet S. The side restricting members 10 can be moved slidably in the width direction and respectively restrict the movement of side ends (both end portions) of the sheet S in the width direction stacked on the sheet tray 4.

The main tray 11 is provided on the side wall portion of the apparatus main body 201A and can stack the sheets S.

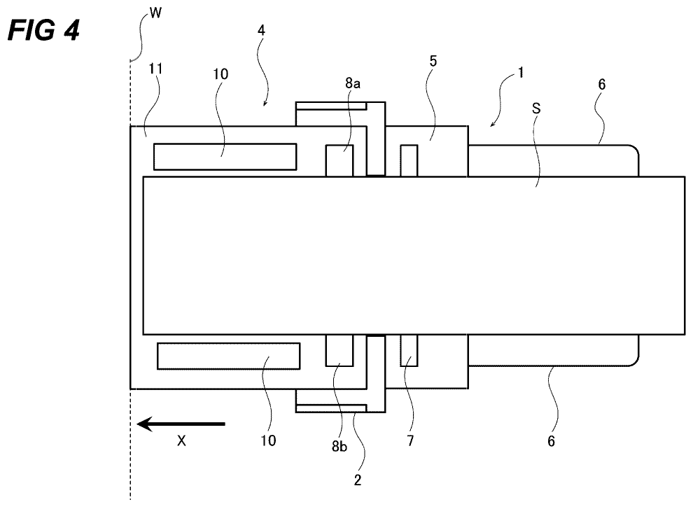

The sheet feeding apparatus 100 with the above configuration restricts the side ends of the sheets S stacked on the extended sheet tray 1 by the side restricting members 10 on the sheet tray 4 as shown in FIG. 4, but does not restricts the side ends on the extended sheet tray 1. The length of the sheets S stacked on the sheet tray 4 and the extended sheet tray 1 is larger than 458.3 [mm] in the feeding direction X.

### <Operation of Sheet Feeding Apparatus >

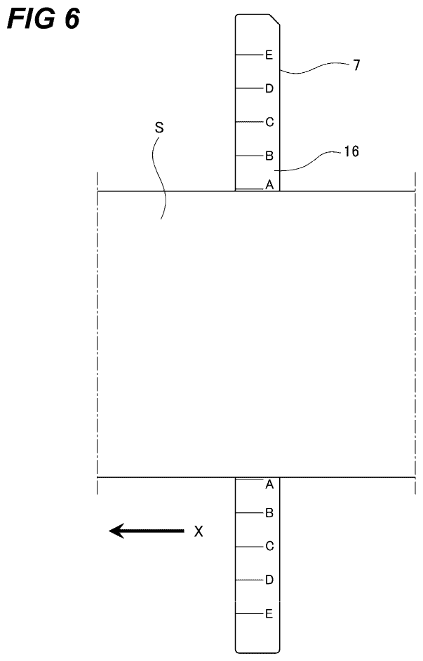

The operation of the sheet feeding apparatus 100 according to the first embodiment of the present invention will be described with reference to FIGS. 2 to 7.

A member for restricting the position of the sheet S in the width direction such as the side restricting members 10 of the main tray 11 is not provided on the extended sheet tray 1. Therefore, it is necessary for the extended sheet tray 1 to have a unit for avoiding the sheet S from being fed in the state where the sheet S is inclined with respect to the feeding direction X.

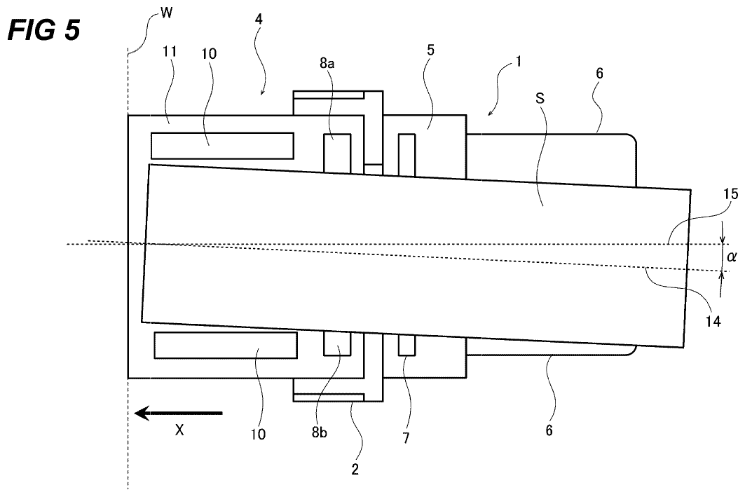

If the positions of the both ends of the long sheet S in the width direction on the upstream side in the feeding direction X of the long sheet S could not be determined, the position of the sheet S in the width direction would be restricted only by the side restricting members 10 on the downstream side in the feeding direction X. In this case, the inclination of the sheet S with respect to the feeding direction X could not be corrected, so that it might be possible that the virtual line 15 parallel to the feeding direction X and the virtual line 14 which connects the center positions in the width direction of the sheet S are not parallel (see FIG. 5). In this case, the sheet S would be fed in the state where the sheet S is inclined to the feeding direction X for the angle α.

In contrast, in the sheet feeding apparatus 100 according to the present embodiment, in addition to the fact that the movement of the sheet S in the width direction is restricted by the side restricting members 10, both end portions of the sheet S in the width direction can be positioned by the second indication portion 8a and the second indication portion 8b. Further, the first indication portion 7 indicates the positions of both end sides of the sheet S in the state where the side ends of the sheet S are restricted by the side restricting members 10. As a result, in the sheet feeding apparatus 100, both ends of the sheet S in the width direction can be positioned at the upstream side in the feeding direction X by following the index marking 16a, 16b or 16c of the first indication portion 7.

As described above, the position of the sheet S in the width direction is restricted by the side restricting members 10 at the downstream side in the feeding direction X, the position of the sheet S is additionally adjusted by the second indication portion 8a and the second indication 8b, and the position of the sheet S is further adjusted by the first indication portion 7 on the upstream side in the feeding direction X. Therefore, the inclination a of the sheet S can be suppressed and a stable feeding can be realized. Since the positions of both ends of the sheet S in the width direction can be positioned by following the index marking 16a, 16b or 16c of the first indication portion 7 and the second indication portion 8a and the second indication 8b, a user can easily adjust the positions of both end portions of the sheet S in the width direction.

Further, when a short regular-size sheet S is fed, the position of the sheet S in the width direction is restricted by the side restricting members 10 provided on the main tray 11. In this case, the sheet S can be fed by both ends of the short sheet S in the width direction being positioned by following the second indication portion 8a and the second indication 8b, so that the inclination a of the sheet S is surely suppressed.

The present embodiment is provided with the sheet tray 4 and the extended sheet tray 1 provided at the upstream side of the sheet tray 4 in the feeding direction X. The sheet S can be stacked on the sheet tray 4. The sheet tray 4 is provided with the side restricting members 10 that restrict the movement of the sheet S in the width direction. Further, the extended sheet tray 1 is provided with the first indication portion 7 that indicates the positions corresponding to the sizes of the sheets S in the width direction. The sheet tray 4 is provided with the second indication portion 8a and the second indication 8b that indicate the positions corresponding to the sizes of the sheets S in the width direction. With this configuration, the position of the sheet S in the width direction can be adjusted and the sheet feeding apparatus can be made smaller and lighter.

Besides, according to the present embodiment, the second indication portion 8a and the second indication portion 8b are separated from each other in the width direction. Therefore, by providing the second indication portion 8a and the second indication 8b in a minimum necessary range of area, the cost can be reduced.

### Second Embodiment

The configuration of the image forming apparatus according to the second embodiment of the present invention is the same as that shown in FIG. 1 and the description will be omitted.

### <Configuration of Sheet Feeding Apparatus >

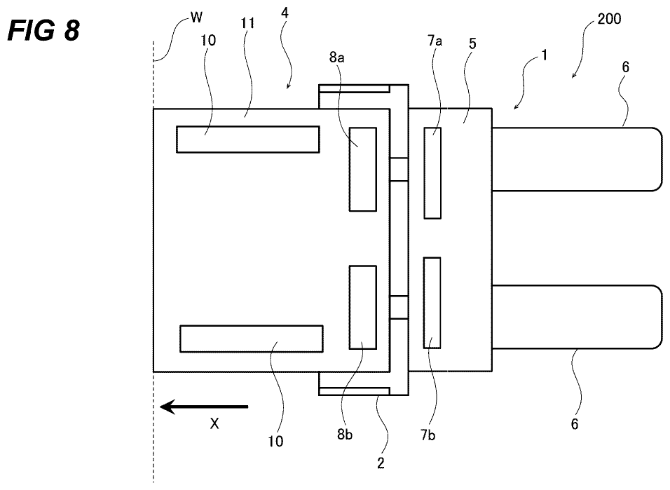

The configuration of the sheet feeding apparatus 200 according to the second embodiment of the present invention will be described in detail with reference to FIG. 8.

In FIG. 8, the same reference characters are attached to the components that are the same as those in FIG. 2 and the description thereof will be omitted.

The sheet feeding apparatus 200 is provided with the extended sheet tray 1 and the sheet tray 4.

The extended sheet tray 1 is attached to the upstream side of the sheet tray 4 in the feeding direction of the sheet S and is provided with the manual feeding attaching portion 2, the sheet stacking portion 5, the wire portion 6, the first indication portion 7a and the first indication portion 7b.

The first indication portion 7a and the first indication portion 7b are provided along the width direction on the sheet stacking portion 5. The first indication portion 7a and the first indication portion 7b respectively indicate the positions corresponding to the sizes of the sheets S in the width direction by the index marking 16a, 16b or 16c. The first indication portion 7a and the first indication portion 7b are separated from each other and divided in the width direction like the second indication portion 8a and the second indication portion 8b.

The operation of the sheet feeing apparatus 200 according to the present embodiment is the same as that of the sheet feeding apparatus 100 and the description thereof will be omitted.

According to the present embodiment, in addition to the effect of the first embodiment, the cost can be reduced by providing the first indication portion 7a and the first indication portion 7b in the minimum necessary range of area since the first indication portion 7a and the first indication portion 7b are divided in the width direction.

The present invention is not limited to the above embodiments and it can be variously modified without departing from the gist of the invention.

Specifically, in the first and second embodiments, the second indication portion 8a and the second indication portion 8b are divided. However, the configuration is not limited to this one and the second indication portion can be of a single shape similar to the first indication portion 7.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-79285, filed May 15, 2024, which is hereby incorporated by reference herein in its entirety.

What is claimed is:

1. A sheet feeding apparatus comprising:
a first sheet stacking portion on which a sheet is stacked;
a sheet side end restricting portion that restricts a side end of the sheet stacked on the first sheet stacking portion; and
a second sheet stacking portion on which the sheet is stacked,
wherein the sheet feeding apparatus further comprises an indication portion provided on the second sheet stacking portion, the indication portion indicating positions of both side ends of the sheet in the state where the side end of the sheet is restricted by the sheet side end restricting portion, and
wherein the second sheet stacking portion is provided in a detachably attachable manner upstream of the first sheet stacking portion in a feeding direction of the sheet.

2. The sheet feeding apparatus according to claim 1,
wherein the indication portion indicates a distance from a conveying center in a width direction perpendicular to the feeding direction.

3. The sheet feeding apparatus according to claim 1,
wherein the indication portion is engraved on a stacking surface of the second stacking portion on which the sheet is stacked.

4. The sheet feeding apparatus according to claim 1,
wherein the side end of the sheet stacked on the second sheet stacking portion is not restricted on the second sheet stacking portion.

5. The sheet feeding apparatus according to claim 1,
wherein the second sheet stacking portion is comprised of a third sheet stacking portion and a fourth sheet stacking provided upstream of the third sheet stacking portion in the feeding direction,
wherein the third sheet stacking portion is made from resin, and
wherein the fourth sheet stacking portion is made from metal.

6. The sheet feeding apparatus according to claim 5,
wherein the indication portion is provided on the third stacking portion.

7. The sheet feeding apparatus according to claim 1,
wherein the sheet stacked on the first sheet stacking portion and the second stacking portion is longer than 458.3 mm in the feeding direction.

8. The sheet feeding apparatus according to claim 1,
wherein the indication portion is provided on the first sheet stacking portion in addition to the second sheet stacking portion, and
wherein the indication portion provided on the first sheet stacking portion indicates a size of the sheet in the width direction perpendicular to the feeding direction of the sheet.

9. The sheet feeding apparatus according to claim 8,
wherein the indication portion provided on the first sheet stacking portion is provided between the sheet side end restricting portion and the indication portion provided on the second sheet stacking portion in the feeding direction.

10. An image forming apparatus comprising:
the sheet feeding apparatus according to claim 1;
an image forming portion configured to form an image on the sheet fed by the sheet feeding apparatus; and
an apparatus main body of the image forming apparatus that accommodates the image forming portion,
wherein the first sheet stacking portion is rotatably provided on a side portion of the apparatus main body.
